(19) United States
(12) Patent Application Publication
(10) Pub. No.: US 2021/0032083 A1
(43) Pub. Date: Feb. 4, 2021

(54) PALLET JACK EXTENDER

(71) Applicant: David Fink, Chicago, IL (US)

(72) Inventor: David Fink, Chicago, IL (US)

(21) Appl. No.: 16/525,368

(22) Filed: Jul. 29, 2019

(51) Int. Cl. B66F 9/14

(52) U.S. Cl. CPC B66F 9/14

(57) ABSTRACT

An extension system for a pallet lift and translate tool is provided including a right fork extension arm having a length, including a right angle bar attached to a right rear cover bracket. A mirrored left fork extension arm is also provided having a length, including at least a left angle bar attached to a left rear cover bracket. With the right rear bracket placed around a right fork of the pallet lift and translate tool, and the left rear bracket placed around a left fork of the pallet lift and translate tool, the right and left angle bars extend away from the body along the forks and the right and left extension arms may be extended past a length of the right and left forks to accommodate lifting pallets having different sizes in relation to lengths of the right and left forks.

### CROSS-REFERENCE TO RELATED DOCUMENTS

N/A

### BACKGROUND OF THE INVENTION

### 1. Field of the Invention

The present invention is in the field of materials transportation and pertains particularly to methods and apparatus for extending the lifting utility of a standard floor-operated pallet jack.

### 2. Discussion of the State of the Art

In the art of transporting material loads, mechanical transfer of shipped materials and goods often occurs between two close shipping points such as in a warehouse where materials and goods may be temporarily stored before being routed to a destination. Materials and goods are typically loaded on skids or pallets when trucked or otherwise transported and are unloaded from transportation vehicles or structures such as bins and moved around on the ground using fork lift equipment including user-operated pallet jacks, which are mechanically adapted to lift loads and transport them on the ground.

A pallet jack is a hand worked hydraulic lifting device on wheels characterized by two sturdy metal forks about 5 feet in length that rest on wheels and that can be lowered and raised via mechanical linkage (obsolete) or via hydraulics (current art). The jack forks are designed to hang very low to the ground when released by a trigger mounted on the handle portion of the jack. Typically, a user drops the forks to slide the jack forks beneath a pallet or skid with materials or goods loaded on it. The user then operates the handle as a jack handle to jack the load up and off the ground so the operator may then maneuver that load.

There are some load limitations (recommendations) for manual pallet jacks such as requiring the use of a drivable forklift for loads much heavier than 3,000 pounds, for example. That limitation is general and does not involve so much calculation of how much weight the jack can lift, but whether the operator will be able to reasonably control the load on the ground once it is lifted and on the pallet jack.

One drawback of pallet jack use may occur if a load is palleted such that the length of the pallet or skid exceeds the length of the pallet jack forks by at least the stock length of the forks. In such a case, the operator may be able to lift the load locally; however, at the other end of the load, the load is dragging on the ground. Another drawback of operating a traditional pallet jack to move loads is that the stock forks of the pallet jack will not fit beneath some pallets or skids correctly because the architecture of the pallets or skids used has different gap measurements, and the architecture or gap measurement between the forks is wrong for those particular pallets or skids.

Therefore, what is clearly needed is a pallet fork extension system that enables a longer reach under longer skids or pallets and which may be used to lift shorter load pallets and skids having architectures not suitable to the wider pallet jack forks.

### BRIEF SUMMARY OF THE INVENTION

The present inventor provides an extension system for a pallet lift and translate tool including a translatable body and two identical forks extending away from the body. One embodiment includes a right fork extension arm having a length, including a right angle bar attached to at least a right rear cover bracket having a top surface and a bottom surface; and a left fork extension arm having a length, including at least a left angle bar attached to a left rear cover bracket having a top surface and a bottom surface. In this embodiment, with the right rear bracket placed around a right fork of the pallet lift and translate tool, and the left rear bracket placed around a left fork of the pallet lift and translate tool, the right and left angle bars extend away from the body along the forks and the right and left extension arms may be extended past a length of the right and left forks to accommodate lifting pallets having different sizes in relation to lengths of the right and left forks.

In this embodiment the right and left forks are parallel having inside edges facing each other and the right and left angle bars are adjacent to and run along the inside edge of the right and left fork, respectively. Additionally, a right middle cover bracket and a left middle cover bracket are attached to the right and left angle bars, respectively, at a position away from the right and left rear cover brackets; the right and left middle cover brackets each including a top surface and bottom surface.

An alternative embodiment provides that the left and right rear cover brackets and the right and left middle cover brackets include openings at their bottom surface enabling engagement of a locking cable to secure each bracket in position. In one embodiment, the right and left extension arms are fabricated from right and left steel rear cover brackets jigged and welded to right and left steel angle bars to form each extension arm. Another embodiment the extension arms are fabricated from hot rolled steel (HRS) AST-36 grade.

A method for extending a length of dual forks extending away from a body of a pallet lift and translate tool is provided, comprising the steps including attaching a left fork extension arm having a left rear cover bracket attached to a left angle bar running a length of a left fork of the tool, to the left fork of the tool by positioning the left rear cover bracket over the left fork. Next, attaching a right fork extension arm having a right rear cover bracket attached to a right angle bar running a length of a right fork of the tool, to the right fork of the tool by positioning the right rear cover bracket over the right fork. Finally, a length of the right and left forks is extended by translating the right and left rear cover brackets away from the body enabling the right and left angle bars to extend past the lengths of the right and left forks.

### BRIEF DESCRIPTION OF THE SEVERAL VIEWS OF THE DRAWINGS

FIG. 1 is a front perspective view of a pallet jack adapted with a lift extension system extended for lifting according to an embodiment of the present invention.

FIG. 2 is an exploded overhead view of the lift extension system of FIG. 1 positioned rearward against the base of the pallet jack while the system is not required in lifting loads.

FIG. 3A is a side elevation view of one lift extension arm of the lift extension to system of FIG. 1.

FIG. 3B is an overhead view of the same lift extension arm of FIG. 3A.

FIG. 4 is a partial underside exploded view of the rear extension mounting bracket of the left lift extension arm of the lift extension system of FIG. 1.

FIG. 5A is an inverted front-end view of the right lift extension arm of the lift extension system of FIG. 1.

FIG. 5B is an inverted front-end view of the left extension arm of the lift extension system of FIG. 1.

FIG. 6 is a side elevation view of the pallet jack adapted with the lift extension system of FIG. 1 positioned to lift a load according to an embodiment of the present invention.

FIG. 7 is a process flow chart depicting steps for installing and either deploying or retracting the lift extension system adapted for integration with the pallet jack of FIG. 1.

### DETAILED DESCRIPTION OF THE INVENTION

In various embodiments described in enabling detail herein, the inventor provides a unique pallet lift extension system for a mechanical pallet jack that extends the under reach of the pallet forks for lifting longer pallet loads and provides an alternate lifting interface for odd designed pallets that cannot be lifted by the standard forks on the jack.

One goal of the present invention is to provide an efficient light weight means to extend the linear lifting capability of a traditional pallet jack by providing a pallet fork extension system that a user may attach to and reserve on a standard pallet jack operated by traditional hydraulic components. Another goal of the present invention is to enable an alternate pallet jack fork architecture that may be used to get under smaller loads that the standard pallet forks cannot penetrate because of the design pf the skid or pallet. Additionally, the extension may enable lifting of more than one pallet at a time by the pallet jack. The present invention is described in enabling detail using the following examples, which may describe more than one relevant embodiment falling within the scope of the present invention.

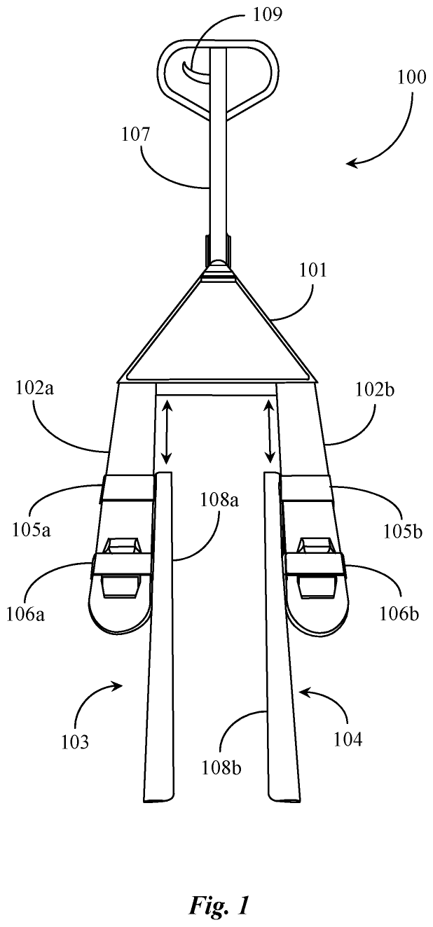

FIG. 1 is a front perspective view of a pallet jack 100 adapted with a lift extension system comprising a right-hand lift extension arm 103 and a left-hand lift extension arm 104 extended for lifting a load according to an embodiment of the present invention.

Pallet jack 100 includes a pallet wheeled base 101(wheels not visible) connected to a hydraulic pallet jack handle 107 that supports a hydraulic pressure release lever 109 for dropping the elevation of the forks. Pallet handle 107 functions as a steering mechanism for the operator managing a pallet load. Pallet jack 100 includes a right fork 102a, and a left fork 102b (from the perspective of an operator). Wheels are typically located under base 101, under the rear end of the pallet jack forks, and near the front end of the pallet jack forks. Additional controls may be provided to pallet jack 100 without departing from the spirit and scope of the present invention. Such standard controls such as a jack handle position lock, pallet breaks, etc. may be assumed present in this embodiment as components of a standard pallet jack like pallet jack 100.

The pallet jack extension system includes a right fork extension arm 103 and a left fork extension arm 104. Lift fork extension arms 103 and 104 are fabricated of durable metal materials such as steel brackets jigged and welded to an elongated steel angle bar to form each extension arm. In one embodiment hot rolled steel (HRS) AST-36 grade is used to fabricate the lift extension arm. Other durable steel grades or other durable metals may also be used without departing from the spirit and scope of the present invention. Extension arms 103 and 104 are mirror image parts one right-handed part and one left-handed part from the perspective of the pallet jack operator. Lift extension arm 103 includes an angle bar 108a supporting a pallet lift fork rear cover bracket 105a welded to angle bar 108a at the rear end of the extension. Angle bar 108a also supports a second pallet lift fork middle cover bracket 106a welded to the same side of angle bar 108a further up on the part. Lift extension 104 includes angle bar 108b, a pallet lift fork rear cover bracket 105b, and a pallet lift fork middle cover bracket 106b.

In this view, lift extension arms 103 and 104 are urged forward from a rear stow position on the mechanical pallet jack to a position enabling extended lift capabilities as is indicated by the double arrows. A cinch-able steel cable lock (not illustrated) is provided on each to extension arms 103 and 104 and is used beneath rear cover brackets 105a and 105b to secure the extension arms against lifting at the rear when lifting a load on a pallet or skid. In one embodiment extension arms 103 and 104 may be bolted in place at the rear and or at the lift extension position by use of standard hardware, such as a socket wrench.

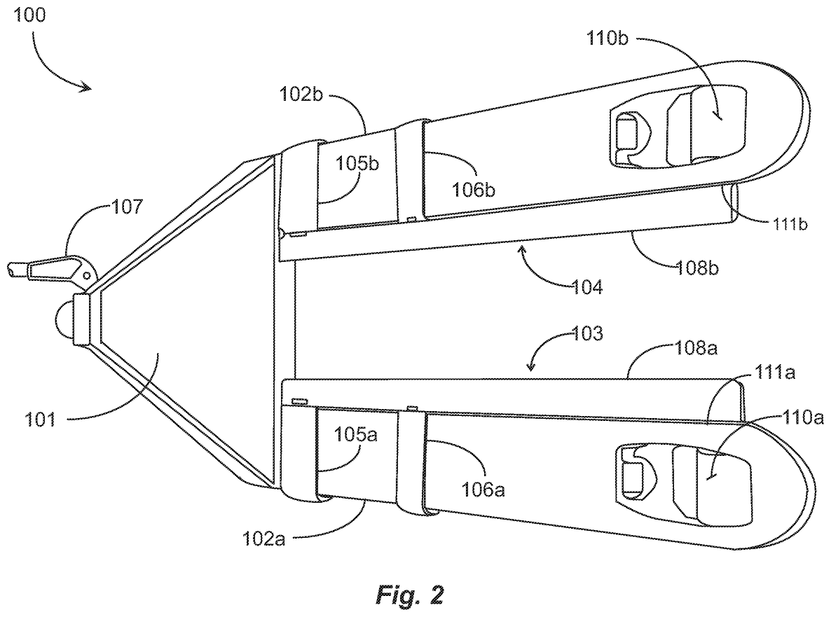

FIG. 2 is an exploded overhead view of pallet jack 100 with lift extension system (103,104) of FIG. 1 positioned rearward against the base of the pallet jack while the system is not required in lifting loads. A portion of pallet handle 107 is removed to conserve drawing space. Lift extension arms 103 and 104 may be urged rearward against pallet jack base 101 as is depicted in this view with cover brackets 105a and 105b flush against pallet jack base 101.

The top surface of extension arms 103 and 104 present substantially parallel and at the same plane or lower than the surfaces of forks 102a and 102b respectively. Referring momentarily back to FIG. 1, cover brackets 106a of extension 103 and 106b of extension 104 rest over the lift-wheel wells of forks 102a and 102b respectively when the lift extension system is urged forward to extend lift capability for host pallet jack 100. The lift wheel-wells host wheels 110a on pallet fork 102a and 110b on pallet fork 102b.

The rear and forward cover brackets are three-sided brackets in this embodiment that are welded to respective angle bars wall-to-wall as the downward facing walls of each angle bar 108a and 108b are positioned along the inside edges 111a and 111b of the pallet forks 102a and 102b respectively. This construction is not necessarily required to practice the present invention, as in one embodiment the cover brackets may be angle brackets having two walls welded to the angle bar extension bars at the interfacing edges without departing from the spirit and scope of the present invention.

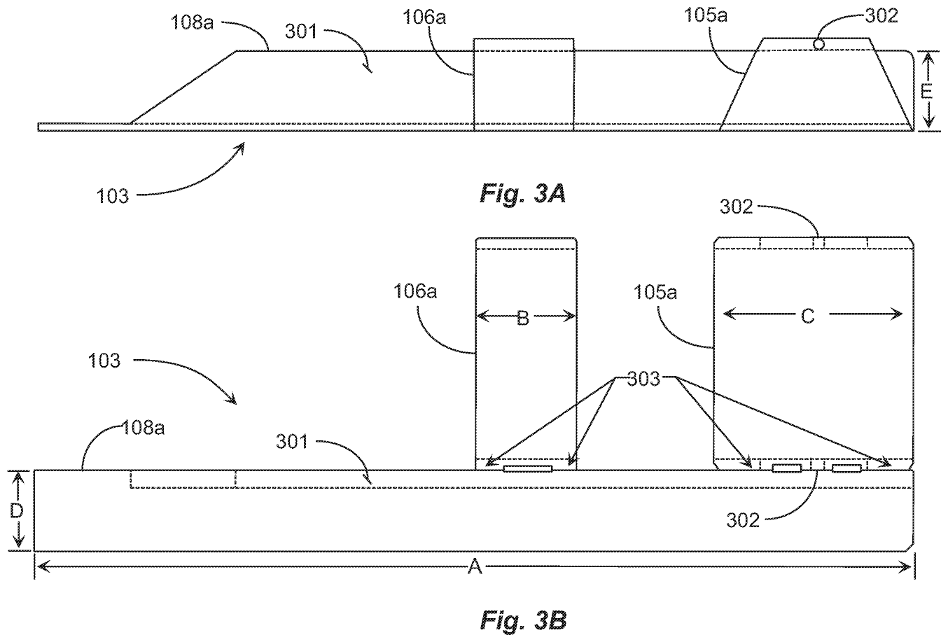

FIG. 3A is a side elevation view of lift extension arm 103 of the lift extension system of FIG. 1. Lift extension arm 103 includes angle bar 108a depicted in an inverted position showing a vertical wall 301 that is substantially parallel to the inside sidewall of pallet fork 103. A height dimension E for the angle bar 108a may be about two and one-quarter inches to two- and one-half inches. The top surfaces of angle bar 108a and cover brackets 105a (rear) and 106a (forward) may be flush. Collectively, the top surfaces of extension arm 103 sit flush with or in a parallel planar position below the top surface of the host fork (102a).

Wall 301 of angle bar 108a is cut at an angle of about forty-five degrees down to the inside surface of the second wall, the cut starting and ending short of the forward edge of the part proximal to the forward end of the extension arm. Rear cover bracket 105a is angle cut inward (both vertical walls) about thirty degrees at both sides. An opening 302 is provided through the walls of cover bracket 105a at the bottom of the bracket that presents beneath the pallet fork. Opening 302 are adapted to accept a stock steel locking cable such as an aircraft cable measuring three thirty-seconds of an inch to one-eighth of an inch in diameter. In one embodiment, angle bar 108a is a rectangular formed angle bar having equal sides relative to height and identical wall thickness of about three sixteenth of an inch. The dimensions cited in this specification shall be understood to be approximate dimensions as material thickness (E), overall part length, and overall part height may vary according to design without departing from the spirit and scope of the present invention.

FIG. 3B is an overhead view of the lift extension arm 103 of FIG. 3A. In this view, vertical wall 301 of angle bar 108a is the wall that cover brackets 105a and 106a are jigged and/or welded to. A small gap space may be maintained between the interfacing walls of the angle bar and cover bracket for weld integrity. Weld locations 303 are depicted in this view. Weld locations 303 may include down the vertical edges of the cover bracket and across the top interfacing edge of the cover bracket. In an alternative embodiment, the parts making up lift extension 103 may be bolted together using standard hardware.

A width dimension C measuring across the top surface of rear cover bracket 105a may be about five inches. The outside-to-outside length measurement of rear cover bracket 105a may be close to seven inches. The main requirement is that the rear cover bracket 105a fits over the host pallet fork and extends down on each side of the fork. Forward cover bracket 106a has a surface width dimension B of about three inches across. A total length dimension A for extension arm 103 may be approximately forty-four inches.

In this embodiment there may be approximately a three sixteenth of an inch gap or space between the inside wall of the host pallet fork and the surface wall 301 of angle bar 108a. Also, in this embodiment, a dimension D measuring across the top surface of lift extension arm 103 may be the same as dimension E of FIG. 3A or about two- and one-half inches. Chamfers, radiused edges, and angled corners may be provided to smooth the edges and sharp corners of a lift extension arm. Further proximal measurements may include a ten-inch spacing dimension between rear cover bracket 105a and forward cover bracket 106a. The forward edge of cover bracket 106a may be approximately 26 inches back from the forward edge of lift extension arm 103.

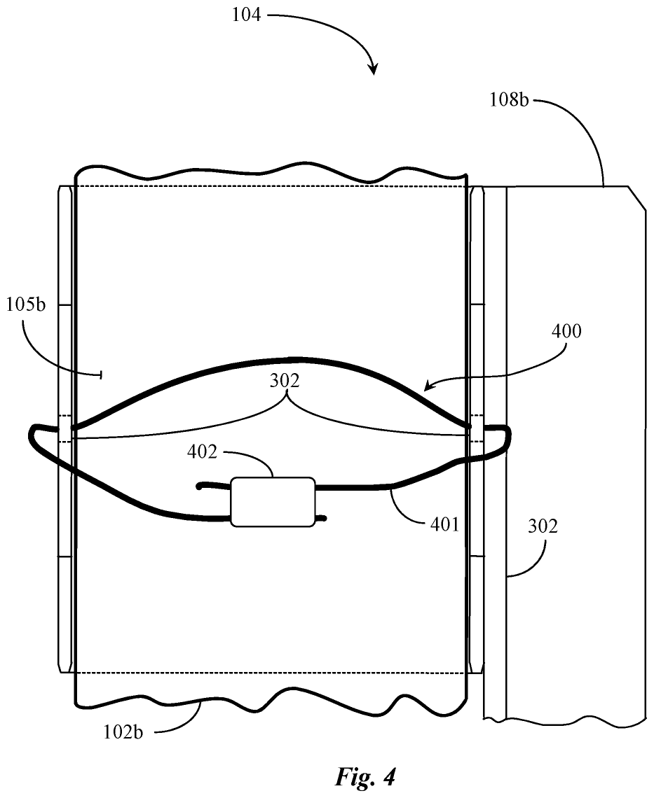

FIG. 4 is a partial underside exploded view of rear extension cover bracket 105b of the lift extension arm 104 of the lift extension system of FIG. 1. Rear cover bracket 105b fits over fork 102b depicted for reference. To prevent cover bracket 105b from lifting off the top of the fork, a steel aircraft locking device 400 is provided. Cable device 400 includes a cinch lock mechanism 402 and a steel cable 401 threaded through channels provided in the lock mechanism and openings 302 at the bottom of rearward cover bracket 105b. The cable may be gauged to about three-thirty seconds to one-eighth of an inch in diameter.

Locking cable 401 functions to keep lift extension arm 103, and 104 in secure position over the host pallet lift fork in a manner that weight load at the end of the arm will not cause separation of the cover bracket (rear of the extension arm) from the surface of the pallet fork (arm tipping). Extension arm 104 stays level in operation to the pallet lift fork of the mechanical pallet. It is noted herein that the opening 302 for cable 401 may extend past the edge of the vertical wall 301 of angle bar 108b.

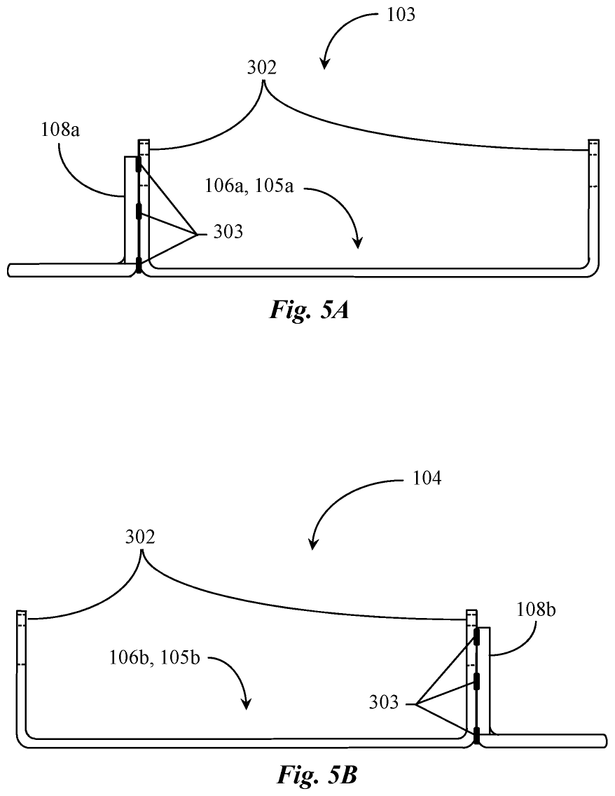

FIG. 5A is an inverted front-end view of right-side lift extension arm 103 of the lift extension system of FIG. 1. Angle bar 108a is depicted side-by-side with rear and forward cover brackets 106a and 105a respectively. In this view forward cover bracket 106a sits directly in line and forward of rear cover bracket 105a. Weld locations 303 are depicted herein between the angle bar and bracket and are the recommended weld locations along the vertical edges of the brackets to the angle bar surface and across the top seam between the parts. Material relief may be provided where required to create welding gaps and to remove sharp edges and corners.

FIG. 5B is an inverted front-end view of the left-side lift extension arm 104 of the lift extension system of FIG. 1. Lift extension arm 104 is a mirror image to extension arm 103. In one embodiment there may be more than one forward bracket provided to be welded to the angle bar without departing from the spirit and scope of the invention.

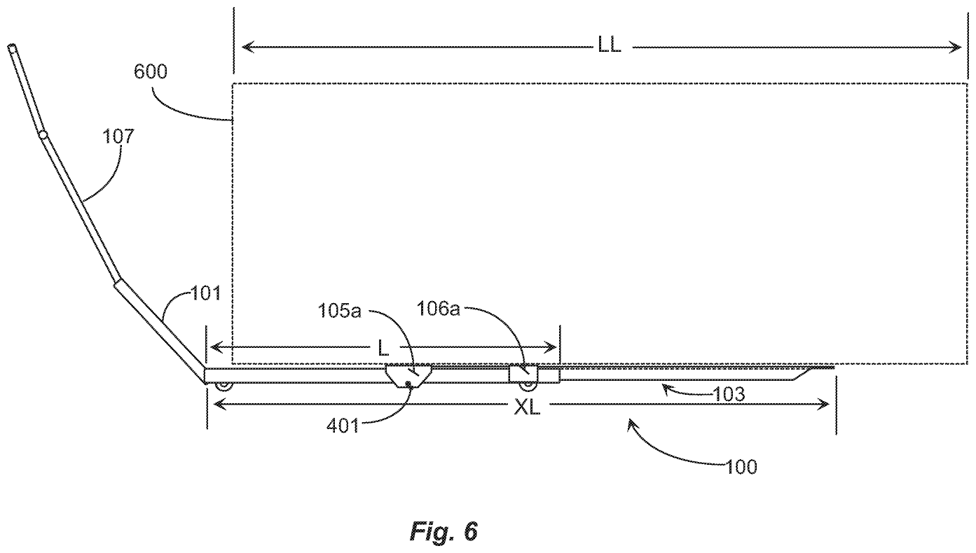

FIG. 6 is a side-elevation view of pallet jack 100 adapted with the lift extension system (right lift arm 103) of FIG. 1 positioned to lift a load 600 according to an embodiment of the present invention. In this view, pallet jack 100 is pushed under a pallet load (pallet not illustrated) that is quite longer than a short load or a standard pallet jack with no lift arm extensions could be used to lift. Without lift arms extended, load 600 would likely drag on the ground at the side furthest away from an operator. In this embodiment, pallet jack 100 is extended fully under load 600 by length dimension L representing the standard length of the pallet forks of pallet jack 100.

Extension arm 103 is extended to a position where forward bracket 106a is over the lift-wheel wheel wells of the pallet forks. Cable 401 keeps rearward bracket 105a from lifting off the top of the pallet forks. The use of the extension system adds length to the standard pallet fork, the total extended length reference herein as length XL. In this example, the extended lift length is more than three quarter of a depicted load length LL for load 600. Typical fork length for a mechanical pallet jack may range from about 36 inches to about 48 inches for longer fork models. At approximately 44 inches in length, lift extensions can add another 30 inches or more to overall load length capacity.

It is noted herein that the lift extension system may be fitted to any mechanical pallet jack and may be provided in different lengths. An adapted mechanical pallet jack may be used to access longer loads that would otherwise not be possible to move with the standard-length jack and shorter loads that could not be lifted with the standard pallet jack because of pallet architecture. A smaller center-to-center gap between the lift extension arms as opposed to the standard fork gap allows more flexibility for an operator to use the extended lift system on a variety of load lengths and pallet designs. The left side of the lift extension system includes like elements in a mirrored orientation.

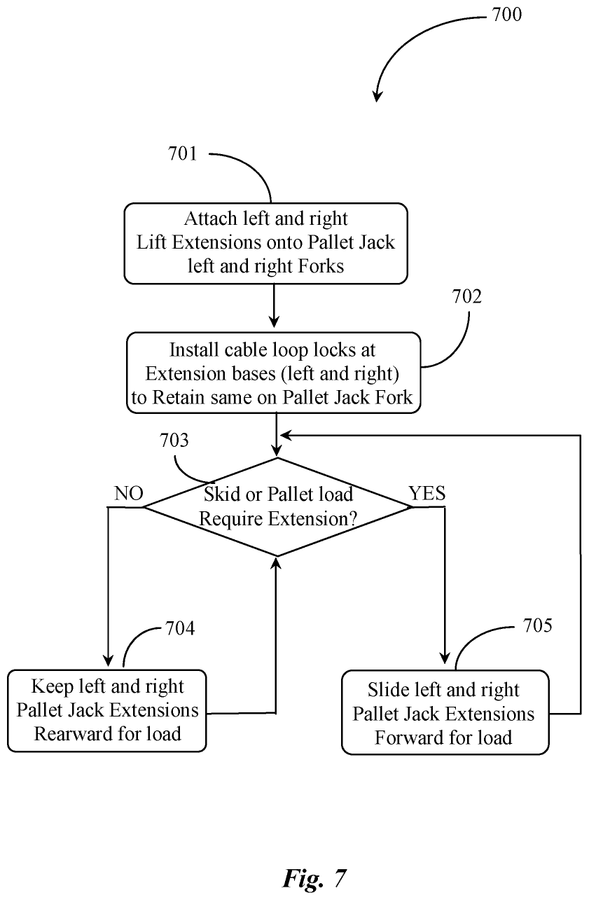

FIG. 7 is a process flow chart 700 depicting steps for installing and deploying or retracting the lift extension system adapted for integration with the pallet jack of FIG. 1. At step 701, an operator expecting to use the lift extension system may install the pallet jack lift extension system. The operator may attach the right-side lift extension arm to the right fork of the pallet jack, and the left-side lift extension arm to the left fork of the pallet jack.

At step 702, the operator may secure the attachments by installing cable loop locks to each lift extension arm at the rearward cover brackets beneath the pallet forks. The cable may be threaded through the provided openings and the lock mechanism may be used to cinch up the slack on the cable loop. In this step, the lift extension arms are urged rearward so that the back edges of the lift arms are flush against the base of the pallet jack. In this state, the pallet jack is ready for enhanced lifting should that be required.

At step 703, the operator may make a determination whether a pallet or skid load requires extension of the lift arms. If at step 703, the operator determines there is no need for enhanced lifting capability, the operator may use the pallet jack with the lift extension arms installed in a normal use position, which is urged rearward against the pallet base. The operator may operate the pallet jack to work with loads that could be moved with a stock pallet jack with no extension arms installed. The rearward position of the lift-extension arms does not impede with normal pallet jack operation.

If at step 703 the operator determines that a load requires enhanced lifting capability for the pallet jack, then the process moves to step 705. At step 705, the operator may manually slide both the left and right lift-extension arms to the forward position for lifting a load. The process may continue to loop back to the operator determination step during the work period as the operator may move through some loads that do not require lift extension and some that do.

In one embodiment the lift-extension arms may be permanently fitted to a pallet jack and may be put into use when required by urging both the left and right extension arms to the forward positions. In one embodiment, a cable hook or hooks may be installed to lock the lift extension arm at a certain linear position along a pallet jack fork. In another embodiment, more than one slide-out position may be identified and utilized by the operator for different load characteristics. For example, all the way back is a stow position, a middle slide out point for loads not requiring a full extend, and a full forward position (maximum extension) for those loads requiring full extension.

In one embodiment of the present invention, a pallet jack may be designed with a linear track mounted to each pallet fork wherein the lift-extension arms are mounted to the tracks and moved rearward or forward using a hydraulic system, or a linear actuated electrical system to change the positions of the lift extension arms relative to the pallet forks.

It will be apparent to one with skill in the art that the pallet jack integrated lift-extension system of the invention may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented within the scope of the invention. The invention is limited only by the breadth of the claims below.

1. An extension system for a pallet lift and translate tool including a translatable body and two identical forks extending away from the body, comprising:
a right fork extension arm having a length, including a right angle bar attached to at least a right rear cover bracket having a top surface and a bottom surface; and
a left fork extension arm having a length, including at least a left angle bar attached to a left rear cover bracket having a top surface and a bottom surface;
wherein the with the right rear bracket placed around a right fork of the pallet lift and translate tool, and the left rear bracket placed around a left fork of the pallet lift and translate tool, the right and left angle bars extend away from the body along the forks and the right and left extension arms may be extended past a length of the right and left forks to accommodate lifting pallets having different sizes in relation to lengths of the right and left forks.

2. The extension system of claim 1, wherein the right and left forks are parallel having inside edges facing each other and the right and left angle bars are adjacent to and run along the inside edge of the right and left fork, respectively.

3. The extension system of claim 1, wherein a right middle cover bracket and a left middle cover bracket are attached to the right and left angle bars, respectively, at a position away from the right and left rear cover brackets; the right and left middle cover brackets each including a top surface and bottom surface.

4. The extension system of claim 3, wherein the left and right rear cover brackets and the right and left middle cover brackets include openings at their bottom surface enabling engagement of a locking cable to secure each bracket in position.

5. The extension system of claim 1, wherein the right and left extension arms are fabricated from right and left steel rear cover brackets jigged and welded to right and left steel angle bars to form each extension arm.

6. The extension arm of claim 5, wherein hot rolled steel (HRS) AST-36 grade is used to fabricate the lift extension arm.

7. A method for extending a length of dual forks extending away from a body of a pallet lift and translate tool, comprising the steps of:
(a) attach a left fork extension arm having a left rear cover bracket attached to a left angle bar running a length of a left fork of the tool, to the left fork of the tool by positioning the left rear cover bracket over the left fork;
(b) attach a right fork extension arm having a right rear cover bracket attached to a right angle bar running a length of a right fork of the tool, to the right fork of the tool by positioning the right rear cover bracket over the right fork;
(c) extending a length of the right and left fork by translating the right and left rear cover brackets away from the body enabling the right and left angle bars to extend past the lengths of the right and left forks.

8. The method of claim 7, wherein the right and left forks are parallel having inside edges facing each other and the right and left angle bars are adjacent to and run along the inside edge of the right and left fork, respectively.

9. The method of claim 7, wherein a right middle cover bracket and a left middle cover bracket are attached to the right and left angle bars, respectively, at a position away from the right and left rear cover brackets; the right and left middle cover brackets each including a top surface and bottom surface.

10. The method of claim 9, wherein the left and right rear cover brackets and the right and left middle cover brackets include openings at their bottom surface enabling engagement of a locking cable to secure each bracket in position.
